(19) United States
(12) Patent Application Publication
(10) Pub. No.: US 2014/0279002 A1
(43) Pub. Date: Sep. 18, 2014

(54) ENHANCEMENT OF USER AFFINITY EXPERIENCE BASED ON OFFERS RELATED TO A GEOGRAPHIC AREA

(71) Applicant: BANK OF AMERICA CORPORATION, Charlotte, NC (US)

(72) Inventors: David M. Grigg, Rock Hill, SC (US); Laura Corinne Bondesen, Charlotte, NC (US); Robert Scott Ellis, Aston, PA (US)

(73) Assignee: BANK OF AMERICA CORPORATION, Charlotte, NC (US)

(21) Appl. No.: 13/803,340

(22) Filed: Mar. 14, 2013

(51) Int. Cl. G06Q 30/02

(52) U.S. Cl. CPC G06Q 30/0261
USPC 705/14.58

(57) ABSTRACT

Systems, methods, and computer program products enhance the affinity experience for affinity account holders by providing offers related to the user's geographic location. In the various systems, location data is received from a mobile device of the user that is in communication with the system, a geographic area of the mobile device is identified based on the location data, at least a portion of the geographic area associated with an affinity object associated with a financial vehicle of the user is determined, and one or more offers associated with the affinity object is identified based on the geographic area.

### BACKGROUND

Consumers often travel to a wide range of places for many different reasons. Supplying mobile customers with the most up-to-date and useful offers and information can be difficult because businesses may not know the interests and locations of their customers in real time. Such difficulty in providing customers with relevant offers and information can lead to missed product and customer enhancement opportunities.

### BRIEF SUMMARY

The embodiments provided herein are directed to a system for providing offers to a user. In some embodiments, the system includes a computer apparatus including a processor and a memory and an offer software module stored in the memory, comprising executable instructions that when executed by the processor cause the processor to: receive location data from a mobile device of the user that is in communication with the system. In some embodiments, the executable instructions further cause the processor to identify a geographic area of the mobile device based on the location data. In some embodiments, the executable instructions further cause the processor to determine that at least a portion of the geographic area is associated with an affinity object associated with a financial vehicle of the user. In some embodiments, the executable instructions further cause the processor to identify one or more offers associated with the affinity object based on the geographic area.

In other embodiments of the systems, the executable instructions further cause the processor to present the one or more offers on the display of the mobile device of the user. In still other embodiments, the affinity object comprises an entity, an organization, an event, or an item of interest to the user. In some embodiments, the executable instructions further cause the processor to receive second location data from the mobile device of the user, wherein the second location data is received after the first location data; calculate the length of time that the mobile device has been in the geographic area based on the time of receipt of the first location data and the second location data; determine the length of time is greater than a preset threshold; and present the one or more offers to the user based on the determined length of time.

In additional embodiments of the system, the location data comprises geographic coordinates, an image captured by the mobile device, a text message sent from the mobile device, or on online entry posted by the mobile device. In other embodiments, the executable instructions further cause the processor to: narrow the location of the mobile device to a precise area in the geographic area based on the geographic coordinates; determine that the mobile device has crossed an imaginary geographic line positioned in the precise area. In still other embodiments, the executable instructions further cause the processor to: determine that the user of the mobile device has entered a building in the geographic area. In further embodiments, the executable instructions further cause the processor to: determine the location of the affinity object based on the location data; determine the distance between the affinity object and the mobile device; and present the one or more offers to the user based on the determined distance.

In further embodiments of the system, the executable instructions further cause the processor to: detect merchants in the geographic area, wherein the merchants provide products associated with the affinity object and wherein the one of more offers are provided by the detected merchants. In some embodiments, the executable instructions further cause the processor to identify the one or more offers based on the account age of the financial vehicle. In other embodiments, the executable instructions further cause the processor to detect the location of the affinity object; determine that the affinity object is outside of the geographic area; determine the distance between the boundaries of the geographic area and the affinity object; wherein the one or more offers are identified based on the distance. In still other embodiments, the executable instructions further cause the processor to determine that the geographic area comprises a second affinity object; and identify the one or more offers based on the second affinity object.

Also provided herein, are embodiments directed to a computer program product for providing offers to a user. In some embodiments, the computer program product includes a computer readable storage medium having computer readable program code embodied therewith, the computer readable program code comprising computer readable program code configured to receive location data from a mobile device of the user. In some embodiments, the computer readable program code includes computer readable program code configured to identify a geographic area of the mobile device based on the location data. In some embodiments, the computer readable program code includes computer readable program code configured to determine that at least a portion of the geographic area is associated with an affinity object associated with a financial vehicle of the user. In some embodiments, the computer readable program code includes computer readable program code configured to identify one or more offers associated with the affinity object based on the geographic area.

In additional embodiments of the computer program product, the affinity object comprises an entity, an organization, an event, or an item of interest to the user. In some embodiments, the code further includes computer readable program code configured to present the one or more offers on the display of the mobile device of the user. In other embodiments, the code further includes computer readable program code configured to receive second location data from the mobile device of the user, wherein the second location data is received after the first location data; calculate the length of time that the mobile device has been in the geographic area based on the time of receipt of the first location data and the second location data; determine the length of time is greater than a preset threshold; and present the one or more offers to the user based on the determined length of time.

Further provided herein are computer-implemented methods for providing offers to a user. In some embodiments, the methods include receiving location data from a mobile device of the user. In some embodiments, the methods include identifying, by a processor, a geographic area of the mobile device based on the location data. In some embodiments, the methods include determining, by a processor, that at least a portion of the geographic area is associated with an affinity object associated with a financial vehicle of the user. In some embodiments, the methods include identifying, by a processor, one or more offers associated with the affinity object based on the geographic area.

In further embodiments of the method, the method further includes presenting, by a processor, the one or more offers on the display of the mobile device of the user. In other embodiments, the affinity object comprises an entity, an organization, an event, or an item of interest to the user. In some embodiments, the method further includes receiving second location data from the mobile device of the user, wherein the second location data is received after the first location data; calculating the length of time that the mobile device has been in the geographic area based on the time of receipt of the first location data and the second location data; determining the length of time is greater than a preset threshold; and presenting the one or more offers to the user based on the determined length of time.

### BRIEF DESCRIPTION OF THE SEVERAL VIEWS OF THE DRAWINGS

The present embodiments are further described in the detailed description which follows in reference to the noted plurality of drawings by way of non-limiting examples of the present embodiments in which like reference numerals represent similar parts throughout the several views of the drawings and wherein:

FIG. 1 provides a block diagram illustrating a system and environment for enhancing a user's affinity experience in a geographic area;

FIG. 2 provides a block diagram illustrating the financial institution system, the third party system, and the user capture device of FIG. 1, in accordance with various embodiments;

FIG. 3 is a flowchart illustrating a system and method for analyzing and providing offers to a user in a geographic location in accordance with various embodiments;

FIG. 4 is a flowchart illustrating a system and method for analyzing and providing topic notifications to a user in a geographic location in accordance with various embodiments; and

FIG. 5 is an illustration of a GUI of a mobile device for enhancing a user's affinity experience in a geographic area in accordance with various embodiments.

### DETAILED DESCRIPTION

The embodiments presented herein are directed to systems, methods, and computer program products for enhancing a user's affinity experience in a geographic location. In specific embodiments, the geographic location of the user's mobile device is detected. The user includes customers of a financial institution that hold financial vehicles or accounts associated with an affinity object. Offers or messaging related to the affinity object are provided to the user in the detected geographic location. In this way, financial institutions add value and strengthen their relationship with affinity account holders.

The embodiments of the disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present embodiments of the disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present embodiments of the disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present embodiments of the disclosure are described below with reference to flowchart illustrations and/or block diagrams of methods, apparatus (systems) and computer program products according to embodiments of the embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As presented herein, embodiments directed to enhancing a user's affinity experience is provided. In specific embodiments, offers are identified, distributed, and modified based on the geographic location of a user or a user's mobile device are provided. As used herein, the term “offer” refers to, but is not limited to promotions, incentives, rewards, or discounts for products (e.g., goods and/or services). Exemplary rewards include rebates, coupons, points, cash back, gift cards, account upgrades, membership upgrades, program upgrades, favorable interest rates, free products, free memberships, cost waivers, and the like. In other embodiments, the user's affinity experience is enhanced by presenting topic notifications or messages related to an affinity object co-located with the user's mobile device.

Referring now to the figures, FIG. 1 provides a block diagram illustrating a system and environment 100 for enhancing a user's affinity experience. The system 100 includes a user 110 and a user's mobile device 112. Such a mobile device may include, but is not limited to, a cellular telecommunications device (i.e., a cell phone or mobile phone), personal digital assistant (PDA), smartphone, a mobile Internet accessing device, or other mobile device including, but not limited to portable digital assistants (PDAs), pagers, gaming devices, laptop computers, tablet computers, and any combination of the aforementioned, or the like. The system 100 further includes a third party system 120 and financial institution system 130. Each of the mobile device 112, the third party system 120, and the financial system 130 are in communication with each other via a network 150. The third party system 120 includes one or more systems associated with a merchant, an offer provider, a third party financial institution, and the like.

As shown in FIG. 1, the user 110 and the user's mobile device 112 are positioned in a geographic area 114. In some embodiments, the geographic area 114 comprises a precise area 116. In the illustrated embodiments, the precise area 116 is a sub-area of the geographic area 114. The precise area 116 may include, for example, a town within a county, portion of a town, a neighborhood in a city, a building on a street, a floor in a building, and the like. As further illustrated in FIG. 1, the geographic area 114 comprises affinity objects 118A and 118B. The affinity object 118A is located outside the precise area 116 and the affinity object 118B is located inside the precise area 116. Also illustrated is affinity object 118C, which is associated with the geographic area 114, but not located within the boundaries of the geographic area 114. Based on the locations of the user 110, the user's mobile device 112, and/or the affinity objects 118A, 118B, and/or 118C, offers or topic notifications can be provided to the user 110 as described in more detail below with regard to FIGS. 3-5.

Referring now to FIG. 2, a block diagram illustrates an environment 200 for providing offers and topic notifications for enhancing a user's affinity experience. The environment 200 includes the mobile device 112, the third party system 120, and the financial institution system 130 of FIG. 1. The environment 200 further includes one or more other third party systems 292 (e.g., a partner, agent, or contractor associated with the third party and/or the financial institution), one or more other financial institution systems 294 (e.g., a credit bureau, third party banks, and so forth), and one or more external systems 296. The systems and devices communicate with one another over the network 150 and perform one or more of the various steps and/or methods according to embodiments of the disclosure discussed herein. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet.

The mobile device 112, the third party system 120, and the financial institution system 130 each includes a computer system, server, multiple computer systems and/or servers or the like. The financial institution system 130, in the embodiments shown has a communication device 242 communicably coupled with a processing device 244, which is also communicably coupled with a memory device 246. The processing device 244 is configured to control the communication device 242 such that the financial institution system 130 communicates across the network 150 with one or more other systems. The processing device 244 is also configured to access the memory device 246 in order to read the computer readable instructions 248, which in some embodiments includes an offer application 250, a topics notification or messaging application 252, and a location detection application (not shown). The memory device 246 also includes a datastore 254 or database for storing pieces of data that can be accessed by the processing device 244.

As used herein, a “processing device,” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 214, 244, or 264 may further include functionality to operate one or more software programs based on computer-executable program code thereof, which may be stored in a memory. As the phrase is used herein, a processing device 214, 244, or 264 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory device” generally refers to a device or combination of devices that store one or more forms of computer-readable media and/or computer-executable program code/instructions. Computer-readable media is defined in greater detail below. For example, in one embodiment, the memory device 246 includes any computer memory that provides an actual or virtual space to temporarily or permanently store data and/or commands provided to the processing device 244 when it carries out its functions described herein.

The user's mobile device 112 includes a communication device 212, a GPS device 216, and an image capture device 215 (e.g., a camera) communicably coupled with a processing device 214, which is also communicably coupled with a memory device 217. The processing device 214 is configured to control the communication device 212 such that the user's mobile device 112 communicates across the network 150 with one or more other systems. The processing device 214 is also configured to access the memory device 217 in order to read the computer readable instructions 218, which in some embodiments includes a capture application 220 and a location application 221. The memory device 217 also includes a datastore 222 or database for storing pieces of data that can be accessed by the processing device 214.

The third party system 120 includes a communication device 262 communicably coupled with a processing device 264, which is also communicably coupled with a memory device 266. The processing device 264 is configured to control the communication device 262 such that the third party system 120 communicates across the network 150 with one or more other systems. The processing device 264 is also configured to access the memory device 266 in order to read the computer readable instructions 268, which in some embodiments includes an offer application 270 and a location detection application (not shown). The memory device 266 also includes a datastore 262 or database for storing pieces of data that can be accessed by the processing device 264.

In some embodiments, each of the capture application 220, the location application 221, and the offer application 270 interacts with the offer application 250 and/or messaging application 252 to receive or provide location data, messaging data (e.g., topic notifications), and/or offer data, modify such data, and analyze the data.

The applications 220, 221, 250, 252, and 270 are for instructing the processing devices 214, 244 and 264 to perform various steps of the methods discussed herein, and/or other steps and/or similar steps. In various embodiments, one or more of the applications 220, 221, 250, 252, and 270 are included in the computer readable instructions stored in a memory device of one or more systems or devices other than the systems 120 and 130 and the user's mobile device 112. For example, in some embodiments, the application 220 is stored and configured for being accessed by a processing device of one or more third party systems 292 connected to the network 150. In various embodiments, the applications 220, 221, 250, 252, and 270 stored and executed by different systems/devices are different. In some embodiments, the applications 220, 221, 250, 252, and 270 stored and executed by different systems may be similar and may be configured to communicate with one another, and in some embodiments, the applications 220, 221, 250, 252, and 270 may be considered to be working together as a singular application despite being stored and executed on different systems.

In various embodiments, one of the systems discussed above, such as the financial institution system 130, is more than one system and the various components of the system are not collocated, and in various embodiments, there are multiple components performing the functions indicated herein as a single device. For example, in one embodiment, multiple processing devices perform the functions of the processing device 244 of the financial institution system 130 described herein. In various embodiments, the financial institution system 130 includes one or more of the external systems 296 and/or any other system or component used in conjunction with or to perform any of the method steps discussed herein. For example, the financial institution system 130 may include a financial institution system, a credit agency system, and the like.

In various embodiments, the financial institution system 130, the third party system 120, and the user's mobile device 112 and/or other systems may perform all or part of a one or more method steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of method 300, the other methods discussed below, or other methods, processes or steps discussed herein or not discussed herein.

FIG. 3 illustrates a flowchart providing an overview of a process 300 for providing offers to a user for enhancing the user's affinity experience. One or more devices, such as the one or more mobile devices and/or one or more other computing devices and/or servers of FIG. 1 and FIG. 2, can be configured to perform one or more steps of the process 300, or process 400 described below. In some embodiments, the one or more devices performing the steps are associated with a financial institution. In other embodiments, the one or more devices performing the steps are associated with a merchant, offer provider, business, partner, third party, credit agency, and/or user.

As illustrated at block 302, location data is received from a mobile device of a user. The location data includes positioning data, mobile device data, social network data, and/or Internet search data. The positioning data may include global positioning data. Global positioning data includes any information collected from methods, systems, apparatus, and/or computer programs involving locating a user's position relative to satellites, fixed locations, beacons, transmitters or the like. In some instances, global positioning data is collected from a GPS device, such as a navigation system. Such a navigation system may be, but is not limited to, hardware and/or software that is part of a mobile phone, smartphone, PDA, automobile, watch, or the like. The amount, nature, and type of the global positioning data that is collected may depend on a merchant's relationship or a financial institution's relationship with the user and the amount of information that the user has authorized the merchant, financial institution, or third-party provider to collect. In some embodiments, the global positioning data include snapshots of the user's location at different times. For example, a snapshot of the user's location may be collected each time the GPS software, navigation system, or application is activated. The global positioning data may also include the destination entered by the user, recent searches for locations, attractions, addresses, and so forth. In other instances, the global positioning data may be the complete route being provided to the GPS system's user, including destination, route, alternate routes, anticipated time of arrival, and the like. In some such embodiments, the global positioning data includes an indication if the user selects a detour from a previously selected route, or instructs the navigation system to reach the desired location taking specific roads or avoiding certain roads. In instances where the user's complete route is provided, additional positioning data may not be necessary to project the route of the user or can be used to confirm the user is traveling on along the suggested route.

Mobile device data includes information regarding the location of the user's mobile device. For instance, the location of the mobile phone may be dynamically determined from the cell phone signal and cell towers being accessed by the mobile phone. In other instances, a mobile device may include software or hardware to locate the position of the mobile phone from GPS signals, wireless network locations, and the like. Mobile device data further includes information from an accelerometer that is a part of the mobile device and provides information regarding whether the mobile device is moving, and if so, in what direction. In some embodiments, mobile device data includes the time and location of calls placed using the telephone functionality of a mobile device. In yet other embodiments, the mobile device data includes data collected and analyzed by the hardware and/or software of the mobile device concerning the surrounding environment. In such embodiments, hardware, such as a video capture device, camera or the like and software that is stored in the memory of a mobile device captures a video stream of the environment surrounding the mobile device and through object recognition, compass direction, the location of the mobile device, and other such data identifies information about the objects identified in the surrounding environment and/or the environment itself. For example, in use, a user may use the camera built into her smartphone to collect a real-time video stream that includes images of the façade of a store front and the surrounding area. This image may include the store's name from a marquee, a street address (collected from an image of the numbers on the building and of street signs in the video image) and the direction the smartphone is facing (from a compass in the mobile device). Such information may be sufficient to locate the user's position and potentially the direction the user is facing and/or traveling.

In some embodiments, the positioning data of the user can also be collected from social network data. It will also be understood that “social network” as used herein, generally refers to any social structure made up of individuals (or organizations) which are connected by one or more specific types of interdependency, such as kinship, friendship, common interest, financial exchange, working relationship, dislike, relationships, beliefs, knowledge, prestige, geographic proximity etc. The social network may be a web-based social structure or a non-web-based social structure. In some embodiments, the social network may be inferred from financial transaction behavior, mobile device behaviors, and the like. The social network includes social media web pages, web logs or “blogs,” forums, and other social spaces. Social network data can indicate the user's recent, present, or future location through expressed data. For instance, a user may upload a blog post, comment on a connection's page, send a friend an electronic message that she is traveling to a specific location or that she is currently in a specific city, or on a specific road. Moreover, many already-existing social networks provide users with the ability to “check-in,” “flag,” or otherwise indicate the user's current location. Accordingly, user positioning data collected from social networking data may consist of such indications. Furthermore, many social networks allow users to rate, like, or comment on restaurants, attractions, locations and the like. Accordingly, a user may indicate that she ate at a certain restaurant or business at a given time and thereby provide information about her location at that time. Furthermore, a user may upload photographs to a social networking site and thereby provide information about the user's location. In some instances the user's location may be determined from the picture, (for example a picture of a state line sign, a highway sign, a mile marker etc.) or a caption associated with the picture may indicate the user's location and/or the time the photo was taken.

The positioning data of the user, in some embodiments, is collected from Internet data. Internet data, may include any information relating to the searches conducted by the user or website's visited by the user that suggests the user's present or future location(s). For instance, in preparing for a vacation, a user may conduct searches for hotels, restaurants, or activities in the area where the user will be staying. Similarly, a user may review weather forecasts for locations other than her place of residence indicating that she may soon be traveling to that location. A user may also search for construction or traffic reports indicating future travel along certain roads. Moreover, changes in search patterns may suggest a user's future location. For instance if a user usually uses a web browser application just to read online news articles or to check sports scores but suddenly begins to search for camping gear, hiking manuals and boots it may be indicative that the user is anticipating taking a hiking trip and will be traveling away from her home area. It will be understood that such Internet data may relate to searches or websites visited by the user before she began traveling, however, inasmuch as many mobile devices also include mobile Internet connectivity, it will also be understood that such information may be dynamically collected as the user travels.

As illustrated at block 304, a geographic area associated with the mobile device is identified based on the location data. The geographic area includes, for example, a geographically fenced area, an area with a predetermined shape, size, radius, or dimensions, one or more towns, an area associated with a zip code, a street, a city block, an area associated with a neighborhood, a parking area, an area associated with an organization or entity, a building, an area of a building, and the like. In further embodiments, the geographic area is dynamically defined. For example, in cases where snapshots of the user's location is received, the size or the geographic area may expand or contract and shape of the geographic area may also change.

In some embodiments, the geographic location is identified based on geographic coordinates or other positioning or mobile data provided by a GPS receiver or other location device external or internal to the mobile device or otherwise associated with the user. In alternative or additional embodiments, the system of process 300 identifies the geographic area based on textual entries, images, video, audio or other social network data, and Internet search data associated with the mobile device. For example, textual entries, images, video, or audio captured by the mobile device may be posted in a public online forum such as social media web pages or provided directly to a financial institution via an online baking account, and location evidence included in the images, video, or audio may be used to identify the geographic location. Landmarks (e.g., street signs, buildings, monuments, or highway markers), verbal or textual indicators submitted by the user, and other location evidence can be used to identify the geographic area.

In some embodiments, the geographic area comprises at least a portion of one or more precise areas. The one or more precise areas, in some embodiments, are identified based on the location data. For example, the geographic area may be defined based on coordinate received from a GPS receiver of the mobile device, and the one or more precise areas may be identified based on images or entries the user posts to a social media webpage. The precise area includes, for example, an area that is smaller in size than the geographic area that indicates a more defined position of the user. The one or more precise areas can be used to determine if a user enters, exits, or occupies a defined space such as a building, room, arena, or other precise area within the geographic area. For example, determining that the user has crossed the entrance of a precise area such as a building may be indicated by an imaginary geographic line positioned in the geographic area.

In some embodiments, the one or more precise areas are positioned a certain distance from the outer edges (i.e., the boundaries) of the geographic area. For example, the precise area may be a square or circle positioned in the middle of a larger square or circle that corresponds to the geographic area. In other embodiments, the one or more precise areas overlap the edges of the geographic area such that least one of the precise areas includes a first portion that is inside the geographic area and a second portion that is outside the geographic area. In further embodiments, the one or more precise areas comprise sub-areas. For example, the precise area may be a square subdivided into a grid of four sub-squares. All of the sub-squares may be inside the defined boundary of the geographic area or at least one of the sub-squares may be positioned outside of the boundary.

As illustrated at block 306, at least a portion of the geographic area is determined to be associated with an affinity object(s), the affinity object(s) being associated with a financial vehicle of the user. The affinity object includes anything of interest to the user such as an entity, organization, event, and/or item of interest to the user. Exemplary affinity objects include a sports team, a public figure (e.g., an artist, athlete, or performer), an educational institute, a musical group, an annual sporting or entertainment event, a charity drive, a weather event, a product, an airline, a brand, a merchant, a hobby, a pastime, and the like. The one or more affinity objects are associated with the financial vehicle in any way. For example, an entity associated with the affinity object or the affinity object itself may endorse at least one financial vehicle or associated account of the user. In other examples, a logo, text, image, graphic, or other symbol of the affinity object may be displayed on a credit card or debit card of the user such that the theme of the card includes the affinity object. In still other examples, the user may be a member of a program associated with the affinity object. The at least one financial vehicle includes credit cards, debit cards, gift cards, vouchers, financial accounts, checks, automatic payments, mobile transaction applications, mobile payment vehicles, and the like.

In some embodiments, the one or more affinity objects are determined to be in the geographic area, the one or more precise areas, or sub-areas of the one or more precise areas based on the location data. For example, in instances where the one or more affinity objects include a sports team, if a user is attending a game involving the sports team, then the sports team may be determined to be in the same geographic area as the user. In other cases, where the user is present at a home arena or museum owned or related to the sports team, but the sports team itself is not at the arena or museum, the sports team may still be determined to be in the same geographic location as the user because the arena and museum is associated with, owned by, or endorsed by the sports team. In other embodiments, the location determination is based on outside data. For example, the outside data may include publicly available information or data provided by third parties such as data gathered from news agencies, government entities, social media, the Internet, and the like.

In further embodiments, each of the one or more affinity objects, in whole or in part, is determined to be outside of the geographic area, the one or more precise areas, or sub-areas based on the location data and/or outside data. For example, at least a portion of each of the one or more affinity objects may be determined to be positioned outside of the boundaries of the geographic area such as when the affinity object is spread out over an area that is greater than the geographic area. In other examples, an affinity object may be a certain distance outside of the boundaries of the geographic area such as when the affinity object is located in the same city as the geographic area, but not in the same portion of the city defined by the geographic area. In still other examples, at least one of the affinity objects is positioned inside the geographic area and another affinity object is positioned outside of the geographic area.

As illustrated at block 307, at least one merchant is informed that that the user is located in the geographic area. In some embodiments, the at least one merchant comprises merchants located within or near the geographic area and/or precise locations. In other embodiments, the at least one merchant is associated with the affinity object. For example, if a user enters a shop that is associated with the affinity object, the shop will know that the user has an affinity financial vehicle or account even if the user uses a different financial vehicle to make purchases in the shop. Based on the geographic locations of the user and the affinity object, the at least one merchant can identify offers or other data (e.g., messaging) and provide such offers or other data to the user in real time. The system of process 300 or 400 can also be configured to inform the at least one merchant of the user's geographic location, receive offers or other data from the at least one merchant, and provide the user with the offers or other data.

As illustrated at block 308, one or more offers associated with the affinity object(s) is identified based on the geographic area, the financial vehicle, or user data. The one or more offers include, for example, offers directly relating to affinity object merchandise such as sports paraphernalia and affinity object events such as concert tickets. The one or more offers also include offer indirectly relating to the affinity objects such as products in the same geographic area as the affinity object, but not directly related to the affinity object. For example, the one or more offers may include a discount for food sold at a ball park where an affinity object is located. The one or more offers, in some embodiments, include additional data such as the terms of the offer (e.g., expiration date, locations, and the like), related offers, and the like. As described herein below with regard to FIG. 4, the terms of the offer may be presented along with topic notifications.

In some embodiments, the identification of the one or more offers is based on the location of the one or more affinity objects. For example, in situations where there are multiple affinity objects, the system of process 300 may be configured to only identify offers associated with affinity objects that are located within the geographic area, at least one precise area, or at least one sub-area, and not identify or disregard offers associated with affinity objects outside of the geographic area. In other examples, the system of process 300 may be configured to only identify offers associated with the affinity object that is closest to the user and disregard offers associated with affinity objects farther away from the user. In still other example, the one or more offers are identified for affinity objects that are a certain distance from the user or a certain distance from the boundaries of the geographic area or the one or more precise areas. In further examples, the one or more offers are identified based on the saturation level of the one or more affinity objects. The saturation level includes, for example, the number of different affinity objects in or near the geographic area, the amount of advertising associated with the affinity object in or near the geographic area, the amount of social media data, mobile data, or Internet search data related to the one or more affinity objects by the user and/or other users within or near the geographic area, and the like.

In further embodiments, the identification of the one or more offers is based on the location of merchants or products associated with the one or more offers. For example, offers for products sold or provided by merchants in the geographic area are identified. In other cases, the merchants used to identify the one or more offer may be located outside of the geographic area. Merchants that sell products related to the one or more affinity objects or that are located a certain distance from the boundary of the geographic area may be used to identify the one or more offers. In one specific example, if the geographic area encompasses one square mile, offers associated with businesses located outside of the geographic area and ¼^{th} of a mile from the boundaries of the geographic area may be identified.

In cases where the one or more offers directly relate to the affinity object (e.g., products are endorsed by the affinity object) the merchant may be located a first distance from the user or a first distance outside of the boundaries of the geographic area. In situations where the one or more offers are indirectly related to the affinity object, the merchants providing the offer may be located a second distance from the user or a second distance outside of the boundaries of the geographic area. In some embodiments, the first distance is greater than the second distance. For example, if the affinity object is a brand of computers and if the offer is for a computer of that brand, then the merchant may be located 100 miles away from the user or across the country from the user. If the offer relates to a computer case sold under another brand, only offer related to merchants located within or nearby to the geographic location (e.g., merchants that are 1 mile outside of the geographic area) are identified. In such cases, the user may be willing to travel or go online to pursue direct offers related to affinity objects that are of interest to them and less willing or likely to pursue indirect offers. In other embodiments, the second distance is greater than the first distance. In situations where the indirect offers are located at a distance that is greater than the distance for direct offers, such indirect offers may not be presented to the user. As the offers become less related to the affinity object, a fan attending a sporting event, for example, may be less willing to travel a long distance from the arena to pursue indirect offers.

In additional embodiments, the one or more offers associated with the one or more affinity objects are identified based on financial vehicle data and/or user data. The financial vehicle data includes, for example, the age of the financial vehicle or account, reward programs associated with an account, account policy, transactions associated with the financial vehicle, and the like. The user data includes the number of years the user has been a customer of a financial institution, transaction history, user preferences, the mobile data, the social media data, and the Internet search data.

As illustrated at block 310, the one or more offers are presented to the user. In some embodiments, the one or more offers are displayed on the display of the mobile device. For example, a mobile application such as online banking mobile application or an offer application may be configured to communicate with an offer provider, such as a merchant or a financial institution. Further details regarding the display of the one or more offers on the mobile device is provided below with regard to FIG. 5. In other embodiments, the one or more offers are presented to the user via text, email, an online banking account, or paper mail.

In some embodiments, the one or more offers are presented to the user based on the amount of time the user has remained within or near the geographic area, or in proximity to the one or more affinity objects. Multiple location data, in some embodiments, are received. In such cases, second location data is received from the mobile device of the user, where the second location data is received after the first location data. Based on the time of receipt of the first location data and the second location data, the length of time that the mobile device has been in the geographic location is calculated. In other examples, each of the multiple location data may be received at the same time or nearly the same time and each may include a time stamp that can be used to calculate the length of the time that the user has been positioned within or near the geographic location. In further embodiments, the length of time is compared to a preset threshold. For example, if the length of time is greater than, less than, or equal to the predetermined threshold, or if the length of time falls within a specific range, the one or more offers are presented to the user. If the length of time fails to meet the predetermined threshold, on the other hand, the one or more offers are not presented to the user. In this way, a user will not receive offers for simply passing through an area related to the one or more affinity objects to his or her destination. In other embodiments, the user may receive the one or more offers regardless of the amount of time the user is within or near the geographic area.

In other embodiments, the one or more offers are presented to the user based on the distance between the user and the one or more affinity objects. For example, if the distance between the detected one or more affinity objects and the user or the user's mobile device is less than 20 miles, the one or more offers are presented to the user. If the distance is greater than 20 miles, however, then the one or more offers are not presented to the user. The one or more offers can also be presented to the user based on whether or not at least a portion of at least one of the one or more affinity objects is within the geographic area or a certain distance outside of the boundaries of the geographic area.

In situations where the user is a large distance from the one or more affinity objects (e.g., over 20 miles) or in situations where the precise location of the user cannot be determined in a large geographic area, whether or not to present the one or more offers is based on the user data. For example, if the geographic area comprises an area having a radius greater than 100 miles such as a city or state, it may be difficult to calculate the distance between the one or more affinity objects and the user. In such situations, the user data or data associated with the user's contacts on social networks can be used to determine the distance between the user and the one or more affinity objects. The user may “check in” to a location via a social media web application on their mobile phone or friends of the user may post location data on the user's social network account.

In still other embodiments, the one or more offers are presented to the user based on the number of the identified one or more offers. For example, the offers may be presented to the user if the number of offers is above, below, or at a certain threshold. In other examples, the offers may only presented to the user if there is at least one offer related to each of the one or more affinity objects. If there is more than one affinity object within a geographic region, for example, then offers will only be presented if at least one offer is available for each of the multiple affinity objects. In additional embodiments, the one or more offers are presented to the user based on the terms of the identified one or more offers. For example, offers that include discounts that are less than 20%, reward points that are less than 100 points, coupons for less than $5, and the like may be disregarded and not presented to the user.

As illustrated at block 312, at least one transaction associated with the one or more offers is processed. The at least one transaction includes purchases at a point of sales, online purchases, mobile transactions, and the like. For example, a mobile banking application can be configured to store any number of financial vehicles and process transactions using the stored financial vehicles. In some embodiments, the system of process 300 is configured to apply the terms of the one or more offers to the at least offer and/or authorize payment of the at least one transaction. Although the process 300 in FIG. 3 includes offers, it will be understood that the steps of process 300 may also be applied to the topics and the topic notifications related to process 400 discussed below.

Referring now to FIG. 4, a process 400 for providing topic notifications for enhancing a user's affinity experience is illustrated in accordance with some embodiments. Blocks 302-307 are discussed hereinabove and related to receiving location data from a mobile device of a user, identifying a geographic area associated with the mobile device based on the data, determining that at least a portion of the geographic area is associated with an affinity object associated with a financial vehicle of a user, and informing at least one merchant of the user is located in the geographic area. The topic notifications may be presented in conjunction with or separately from the one or more offer described above. In some instances where no offers associated with one or more affinity objects are identified, the topic notifications are presented instead of the one or more offers.

As illustrated at block 408, one or more topics associated with the affinity object are identified based on the geographic area, user data and/or financial data. In some embodiments, the one or more topics includes news feed, entity statistics, affinity object events, affinity object updates, affinity object images, affinity object audio, affinity object video, affinity object social media data, and the like. In some embodiments, the one or more topics further comprise information related to the geographic area. For example, the one or more topics may include a traffic report, weather report, or map for the geographic area. In some embodiments, the topics are directed related to the affinity object. Directly related topics include, for example, articles, video, and/or audio that include the affinity object or agent of the affinity object, information produced or endorsed by the affinity object or agent of the affinity object, and so forth. In other embodiments, the topics are indirectly related to the affinity object. Indirectly related topics include information that is related to the one or more affinity objects, but that does not include the one or more affinity objects, and/or information that is not endorsed by the one or more affinity objects. Indirect related topics include, for example, player statistics of a sports team that is a competitor to the affinity object sports team.

In further embodiments, the one or more topics are filtered based on the geographic area. The identified topics related to the one or more affinity objects, in some embodiments, are filtered to remove topics unrelated to the geographic area. For example, statistics for a player associated with the user's affinity sports team may be removed from possible topics if the statistics are for an “on the road” game, where the geographic area comprises the “at home” stadium. In additional specific examples, if a first topic is associated with a precise area and a second topic is not associated with the precise area, then the first topic will be presented to the user and the second topic discarded.

In still further embodiments, the one or more topics are identified based on the location of the one or more affinity objects. As discussed herein above, the one or more affinity objects can be located within the geographic area, a certain distance outside of the geographic area, a certain distance from the user, and the one or more affinity objects may be positioned at certain locations relative to each other. Based on calculated distances and the positioning of the one or more affinity objects relative to each other, relative to the geographic area, or relative to the user, the one or more topics can be identified or presented to the user.

In specific embodiments, the one or more topics are identified based on the distance between the affinity object and the user or the user's mobile device. For example, if the user is in a mall and the user has a shoe store affinity credit card and separate clothing store credit card, the distance between the user and each of the stores may be calculated. Based on the calculated distances, topics associated with the shoe store or topics associated with the clothing store may be identified. If the user is positioned closer to the shoe store, then only the shoe store topics may be presented to the user. In other cases, if the topics associated with the clothing store are directly related to the clothing store, then the clothing store topics may also be presented to the user even if the clothing store is farther from the position of the user. If the clothing store topics are indirectly related to the clothing store, the clothing store topics may be discarded if the clothing store is father away from the user than the shoe store.

In additional embodiments, the topics are dynamically identified. For example, topics related to an affinity object event such as a marathon may include points along the marathon route that relate to refreshments or restroom facilities. In such cases, the user will be presented with the refreshment point locations (e.g., a map display on the mobile device) that are closest to the user as the user runs along the route. In this way, only the most urgent or important topics are presented to the user in real time so that the user can remain focused and is not inundated by remote topics. In other cases, however, all of the refreshment point locations are presented on the map display of the mobile device so that the user has a broader view of the geographic area and can plan accordingly.

In other embodiments, the identified one or more topics are prioritized based on the geographic area. Topics related to the one or more affinity objects that are positioned in the sub-areas of the precise areas may be ranked higher than topics related to the one or more affinity object that are positioned in the precise areas and/or the geographic area. For example, if a user has one credit card endorsed by an airline, a second credit card associated with an annual charity drive, and a debit card associated with a comic book hero, topics related to airline travel will rank higher when the user is sitting in an airplane terminal associated with the airline even though the user may also be viewing a movie about the comic book hero and waiting to fly to the city where the annual charity drive takes place. In some cases, the prioritization of the topics is dynamic. Continuing from the previous example, when the user leaves the plane and arrives in the city of the annual charity drive, topics related to the annual charity drive may be ranked above the airline topics. As the user moves farther away from the arrival airport, the ranking of the airline topics may be pushed further down or the topics discarded. Also, if the user stops or pauses the movie, topics related to the comic book hero may be discarded or given lower priority.

In other embodiments, the topics are identified based on user preferences, user demographics, and/or user social media data. The user may, for example, input the types of topics (e.g., affinity object news, analysis, weather, traffic, social media trends, and the like), presentation format, timing of presentation, the number of topics, age of the topics (e.g., how date of news updates, player statistics, and the like), and so forth. In other examples, topics related to the financial health of a company (e.g., stock quotes or mergers) may be removed from the topic data such that only news stories or social media content relating to product reviews, promotions, or product release dates are identified.

In additional embodiments, the topics are identified based on the popularity of the topics and/or the one or more affinity objects. The popularity of the topic or affinity object can be user specific or generalized. For example, the popularity may be based on the user's mobile data, social media data, and/or Internet searching data. If the user has posted entries about an affinity object twelve times in the last month or posted a certain number of entries on eight different web sites, for example, the amount of entries, the length of the entries, the content of the entries, or the variety of the entries can be used to gauge the popularity of the affinity object. The mobile data, social media data, and/or Internet searching data can also be searched for key terms, or analyzed to determine the types of topics that interest the user. The generalized popularity of the topic and/or the one or more affinity object can be based on the number of units sold of an affinity object, the number of comments to a news story or online entry, the amount of positive feedback regarding the affinity object in surveys and product reviews, and the other data not associated with the user.

In still other embodiments, the topics are identified based on the age of the account of the financial vehicle, the type of financial vehicle, the terms of the account, the account history, other financial account data of the user, and the like. For example, if the affinity object is an electronics store, the system of process 400 may compare the user's transaction history using the financial vehicle associated with the electronics store or other transaction vehicles of the user to determine whether or not news related to release dates of a particular product would be of interest to the user when the user is in the electronic store or near to the electronic store's location. In specific embodiments, the timing of previous transactions of the user is used to identify the one or more topics. If the user bought a smart phone two years ago, for example, news articles and product reviews for similar smart phone or new models of the same phone may be identified when the user enters an electronic store associated with the user's credit card, but if the user bought a smart phone in the past two months news articles and product reviews for smart phones may be disregarded.

As illustrated at block 410, one or more topic notifications are presented to the user based on the identified topics. In some embodiments, the topic notifications are presented on the display of the user's mobile device. The topic notifications comprise the one or more identified topics. The topic notifications can be presented to the user in any type of format such as a ticker, a message, a text, and/or an email.

In some embodiments, the one or more topics are presented to the user based on the amount of time the user has remained within or near the geographic area, or in proximity to the one or more affinity objects. In some embodiments, second location data is received from the mobile device of the user, where the second location data is received after the first location data. Based on the time of receipt of the first location data and the second location data, the length of time that the mobile device has been in the geographical location is calculated. In other examples, each of the multiple location data may be received at the same time or nearly the same time and each may include a time stamp that can be used to calculate the length of the time that the user has been positioned within or near the geographical location.

In further embodiments, the length of time is compared to a preset threshold. For example, if the length of time is greater than, less than, or equal to the predetermined threshold, or if the length of time falls within a specific range, the one or more offers are presented to the user. If the length of time fails to meet the predetermined threshold, on the other hand, the one or more offers are not presented to the user. In this way, a user will not receive possibly unwanted topics for simply passing through an area related to the one or more affinity objects. In other embodiments, the user may receive the one or more topics regardless of the amount of time the user is within or near the geographic area. For example, if the user has opted into a program for receiving affinity object related topics, the user may automatically receive the topic notifications. In additional embodiments, the location of the affinity object is dynamic. For example, if the user occupies a geographic location for a set amount of time, but if the affinity object leaves the boundaries of the geographic area (e.g., the affinity object moves more than 10 miles outside of the boundaries of the geographic area or precise areas) the topics related to the affinity object may not be presented to user even if the length of time the user has occupied the geographic area is above the predetermined threshold.

In other embodiments, the one or more topics are presented to the user based on the distance between the user and the one or more affinity objects. For example, if the distance between the detected one or more affinity objects and the user or the user's mobile device is less than 20 miles, the one or more offers are presented to the user. If the distance is greater than 20 miles, however, then the one or more offers are not presented to the user. The one or more topics can also be presented to the user based on whether or not at least a portion of at least one of the one or more affinity objects is within the geographical area or a certain distance outside of the boundaries of the geographical area.

In situations where the user is a large distance from the one or more affinity objects (e.g., over 20 miles) or in situations where the precise location of the user cannot be determined in a large geographic area, whether or not to present the one or more topics is based on the user data. For example, if the geographic area comprises an area having a radius greater than 100 miles such as a city or state, it may be difficult to calculate the distance between the one or more affinity objects and the user. In such situations, the user data or data associated with the user's contacts on social networks can be used to determine the distance between the user and the one or more affinity objects. The user may “check in” to a location via a social media web application on their mobile phone or friends of the user may post location data on the user's social network account.

In still other embodiments, the one or more topics are presented to the user based on the number of the identified one or more topics. For example, the topics may be presented to the user if the number of topics is above, below, or at a certain threshold. In other examples, the topics may only be provided to the user if there is at least one topic related to each of the one or more affinity objects. If there is more than one affinity object within a geographic region, for example, news articles will only be presented if there is at least one topic available for each of the multiple affinity objects. In other cases, the topics identified for each of the one or more affinity objects must be the same type in order to be presented to the user. For example there must be at least one news article topic and at least one social media topic relating to each of the one or more affinity object in order for the different types of topics to be presented to the user.

Referring now to FIG. 5, a graphical user interface (GUI) 502 illustrating the presentation of offers and topic notifications is provided. In the illustrated embodiments, the GUI 502 comprises the display of the mobile device 112. The GUI 502 includes a split screen comprising a first portion 520 and a second portion 530.

As shown in FIG. 5, the first portion 520 includes topic notifications and is entitled “TOPICS FEED.” The second portion 530 includes offers. Each of the first portion 520 and second portion 530 of the GUI 502 can be further divided into smaller screens. In some embodiments, the first portion 520 and second portion 530 are divided based on the one or more affinity objects.

The first portion 520 includes notifications that are divided into a first group 522 associated with a first affinity object, which in FIG. 5 is a sports team, and a second group 526, which is a university. The first group 522 is further divided into various categories such as “Sports Team Headlines” and “Social Media Feed.” Under the headlines category, a link 524A to the article and a link 524B to the video are provided.

The second portion 530 includes a list of offers that the user can click on to review details of the offer and additional information such as directions to a merchant's physical location or a link to the merchant's web page. In some embodiments, the offers are prioritized based on the size of the discount or reward associated with the offer, the type of offer, the products, the brand of products, the merchant, the expiration date, the location of the merchant, and the like.

In some embodiments, the notifications and/or offers are modified. The modification includes, for example, format adjustments, corrections, substantive data changes, changes to the terms of the offer, and the like. For example, titles of articles or social media may be amended to shorten or correct typos, a percent discount of an offer may be increased or decreased, the expiration date of an offer changed, additional data may be added, and the like. The modifications are based on whether or not the user viewed or used past notifications or offers, the transaction history of the user using financial vehicles associated with the affinity object or other financial vehicles, and the like. For example, if a user attended several events sponsored by an affinity object over the past year, but did not click on traffic reports for the area of the event or view offers for new cards, such types of notifications and offers may be modified or removed from the list of notifications and offers displayed on the mobile device display.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to embodiments of the disclosure in the form disclosed. Many modifications and variations will be apparent to those of ordinary skill in the art without departing from the scope and spirit of embodiments of the disclosure. The embodiment was chosen and described in order to best explain the principles of embodiments of the disclosure and the practical application, and to enable others of ordinary skill in the art to understand embodiments of the disclosure for various embodiments with various modifications as are suited to the particular use contemplated. Although specific embodiments have been illustrated and described herein, those of ordinary skill in the art appreciate that any arrangement which is calculated to achieve the same purpose may be substituted for the specific embodiments shown and that embodiments of the disclosure have other applications in other environments. This application is intended to cover any adaptations or variations of the present disclosure. The following claims are in no way intended to limit the scope of embodiments of the disclosure to the specific embodiments described herein.

What is claimed is:

1. A system for providing offers to a user, the system comprising:
a computer apparatus including a processor and a memory; and
an offer software module stored in the memory, comprising executable instructions that when executed by the processor cause the processor to:
receive location data from a mobile device of the user that is in communication with the system;
identify a geographic area of the mobile device based on the location data;
determine that at least a portion of the geographic area is associated with an affinity object associated with a financial vehicle of the user; and
identify one or more offers associated with the affinity object based on the geographic area.

2. The system of claim 1, wherein the executable instructions further cause the processor to:
present the one or more offers on the display of the mobile device of the user.

3. The system of claim 1, wherein the affinity object comprises an entity, an organization, an event, or an item of interest to the user.

4. The system of claim 1, wherein the executable instructions further cause the processor to:
receive second location data from the mobile device of the user, wherein the second location data is received after the first location data;
calculate the length of time that the mobile device has been in the geographic area based on the time of receipt of the first location data and the second location data;
determine the length of time is greater than a preset threshold; and
present the one or more offers to the user based on the determined length of time.

5. The system of claim 1, wherein the location data comprises geographic coordinates, an image captured by the mobile device, a text message sent from the mobile device, or on online entry posted by the mobile device.

6. The system of claim 5, wherein the executable instructions further cause the processor to:
narrow the location of the mobile device to a precise area in the geographic area based on the geographic coordinates;
determine that the mobile device has crossed an imaginary geographic line positioned in the precise area.

7. The system of claim 6, wherein the executable instructions further cause the processor to:
determine that the user of the mobile device has entered a building in the geographic area.

8. The system of claim 1, wherein the executable instructions further cause the processor to:
determine the location of the affinity object based on the location data;
determine the distance between the affinity object and the mobile device;
present the one or more offers to the user based on the determined distance.

9. The system of claim 1, wherein the executable instructions further cause the processor to:
detect merchants in the geographic area, wherein the merchants provide products associated with the affinity object and wherein the one of more offers are provided by the detected merchants.

10. The system of claim 1, wherein the executable instructions further cause the processor to:
identify the one or more offers based on the account age of the financial vehicle.

11. The system of claim 1, wherein the executable instructions further cause the processor to:
detect the location of the affinity object;
determine that the affinity object is outside of the geographic area;
determine the distance between the boundaries of the geographic area and the affinity object;
wherein the one or more offers are identified based on the distance.

12. The system of claim 1, wherein the executable instructions further cause the processor to:
determine that the geographic area comprises a second affinity object; and
identify the one or more offers based on the second affinity object.

13. A computer program product for providing offers to a user, the computer program product comprising:
a computer readable storage medium having computer readable program code embodied therewith, the computer readable program code comprising:
computer readable program code configured to receive location data from a mobile device of the user;
computer readable program code configured to identify a geographic area of the mobile device based on the location data;
computer readable program code configured to determine that at least a portion of the geographic area is associated with an affinity object associated with a financial vehicle of the user; and
computer readable program code configured to identify one or more offers associated with the affinity object based on the geographic area.

14. The computer program product of claim 13, wherein the affinity object comprises an entity, an organization, an event, or an item of interest to the user.

15. The computer program product of claim 14, further comprising computer readable program code configured to
present the one or more offers on the display of the mobile device of the user.

16. The computer program product of claim 13, further comprising computer readable program code configured to
receive second location data from the mobile device of the user, wherein the second location data is received after the first location data;
calculate the length of time that the mobile device has been in the geographic area based on the time of receipt of the first location data and the second location data;
determine the length of time is greater than a preset threshold; and
present the one or more offers to the user based on the determined length of time.

17. A computer-implemented method for providing offers to a user, the method comprising:
receiving location data from a mobile device of the user;
identifying, by a processor, a geographic area of the mobile device based on the location data;
determining, by a processor, that at least a portion of the geographic area is associated with an affinity object associated with a financial vehicle of the user; and
identifying, by a processor, one or more offers associated with the affinity object based on the geographic area.

18. The method of claim 17, further comprising:
presenting, by a processor, the one or more offers on the display of the mobile device of the user.

19. The method of claim 17, wherein the affinity object comprises an entity, an organization, an event, or an item of interest to the user.

20. The method of claim 17, further comprising:
receiving, by a processor, second location data from the mobile device of the user, wherein the second location data is received after the first location data;
calculating, by a processor, the length of time that the mobile device has been in the geographic area based on the time of receipt of the first location data and the second location data;
determining, by a processor, the length of time is greater than a preset threshold; and
presenting, by a processor, the one or more offers to the user based on the determined length of time.
